(19) United States
(12) Patent Application Publication
(10) Pub. No.: US 2024/0105922 A1
(43) Pub. Date: Mar. 28, 2024

(54) NEGATIVE ELECTRODE FOR RECHARGEABLE LITHIUM BATTERY, RECHARGEABLE LITHIUM BATTERY, AND ALL-SOLID-STATE RECHARGEABLE BATTERY

(71) Applicant: SAMSUNG SDI CO., LTD., Yongin-si (KR)

(72) Inventors: Hyuksoo SHIN, Yongin-si (KR); Hwichul YANG, Yongin-si (KR); Jungho LEE, Yongin-si (KR); Juhee SOHN, Yongin-si (KR); Jinhoon YANG, Yongin-si (KR); Sungwon JUNG, Yongin-si (KR)

(21) Appl. No.: 18/370,909

(22) Filed: Sep. 21, 2023

(30) Foreign Application Priority Data
Sep. 22, 2022 (KR) 10-2022-0120145

(51) Int. Cl. H01M 4/36; H01M 4/133; H01M 4/134; H01M 4/38; H01M 4/583; H01M 4/62; H01M 4/66; H01M 10/052; H01M 10/0562; H01M 10/42

(52) U.S. Cl. CPC H01M 4/366; H01M 4/133; H01M 4/134; H01M 4/364; H01M 4/382; H01M 4/583; H01M 4/62; H01M 4/661; H01M 10/052; H01M 10/0562; H01M 10/4235; H01M 2004/027

(57) ABSTRACT

A negative electrode for a rechargeable lithium battery, the negative electrode including a negative electrode current collector, a negative electrode catalyst layer on the negative electrode current collector, and a lithium ion conductive layer on the negative electrode catalyst layer.

### CROSS-REFERENCE TO RELATED APPLICATION

This application claims priority to and the benefit of Korean Patent Application No. 10-2022-0120145 filed in the Korean Intellectual Property Office on Sep. 22, 2022, the entire contents of which are incorporated herein by reference.

### BACKGROUND

### 1. Field

Negative electrode for a rechargeable lithium battery, rechargeable lithium batteries, and all-solid-state rechargeable batteries are disclosed.

### 2. Description of the Related Art

A rechargeable lithium battery has high electrochemical capacity and operation potential and excellent charge and discharge cycle characteristics and thus may be widely used in portable information terminals, portable electronic devices, small household electric power storage devices, motor cycles, electric vehicles, hybrid electric vehicles, and the like, and with the spread of such uses, there is a demand for improving safety and enhancing performance of the rechargeable lithium battery.

### SUMMARY

Embodiments are directed to a negative electrode for a rechargeable lithium battery, the negative electrode including a negative electrode current collector, a negative electrode catalyst layer on the negative electrode current collector, and a lithium ion conductive layer on the negative electrode catalyst layer.

In embodiments the negative electrode current collector may include a copper foil, a stainless steel (SUS) foil, a nickel foil, a titanium foil, or a combination thereof.

In embodiments the negative electrode catalyst layer may include a metal, a carbon material, or a combination thereof.

In embodiments the metal may include gold, platinum, palladium, silicon, silver, aluminum, bismuth, tin, zinc, or a combination thereof.

In embodiments the carbon material may include an amorphous carbon.

In embodiments the negative electrode catalyst layer may include the metal and the carbon material in a weight ratio of about 1:1 to about 1:50.

In embodiments a thickness of the negative electrode catalyst layer may be about 100 nm to about 50 μm.

In embodiments the negative electrode may further include a lithium metal layer formed during initial charging between the negative electrode current collector and the negative electrode catalyst layer.

In embodiments the lithium ion conductive layer may include a lithium-metal composite oxide, the lithium-metal composite oxide may include lithium and a metal other than lithium, and the metal may be one or more element selected from Al, B, Ba, Ca, Ce, Co, Cr, Cu, Fe, La, Mg, Mn, Mo, Nb, Si, Sr, Ta, Ti, V, W, Zn, and Zr.

In embodiments the lithium ion conductive layer may include a lithium titanium oxide, a lithium zirconium oxide, a lithium aluminum oxide, a lithium niobium oxide, a lithium lanthanum oxide, a lithium tantalum oxide, a lithium zinc oxide, a lithium titanium zirconium oxide, a lithium lanthanum titanium oxide, a lithium lanthanum zirconium oxide, a lithium lanthanum titanium zirconium oxide, a lithium lanthanum zirconium aluminum oxide, a lithium strontium tantalum zirconium oxide, or a combination thereof.

In embodiments a thickness of the lithium ion conductive layer may be about 1 nm to about 50 nm.

In embodiments a rechargeable lithium battery, may include the negative electrode, a positive electrode, and an electrolyte.

In embodiments an all-solid-state rechargeable battery, may include the negative electrode, a positive electrode, and a solid electrolyte layer between the positive electrode and the negative electrode.

In embodiments the solid electrolyte layer may include a sulfide-based solid electrolyte.

In embodiments the sulfide-based solid electrolyte may include an argyrodite-type sulfide.

In embodiments the argyrodite-type sulfide may include Li₃PS₄, Li₇P₃S₁₁, Li₇PS₆, Li₆PS₅Cl, Li₆PS₅Br, Li_{5.8}PS_{4.8}Cl_{1.2}, Li_{6.2}PS_{5.2}Br_{0.8}, or a combination thereof.

In embodiments an average particle diameter (D50) of the sulfide-based solid electrolyte may be about 0.1 μm to about 5.0 μm.

In embodiments the negative electrode current collector may include a copper foil.

### BRIEF DESCRIPTION OF THE DRAWINGS

Features will become apparent to those of skill in the art by describing in detail exemplary embodiments with reference to the attached drawings in which:

FIG. 1 shows a schematic cross-sectional view of an all-solid-state rechargeable battery according to some example embodiments;

FIGS. 2 and 3 show cyclic voltammetry (CV) evaluation results for the half-cell of Comparative Example 1;

FIG. 4 shows a CV evaluation result for the half-cell of Comparative Example 2;

FIG. 5 shows an image (left) of the copper foil negative current collector of Comparative Example 1 and an image (right) of the copper foil negative current collector taken after 30 cycles of the half-cell of Comparative Example 1;

FIG. 6 shows a result of a depth profile analysis by TOF-SIMS on the surface of a copper foil negative electrode current collector after 100 cycles of the all-solid-state half-cell of Comparative Example 1;

FIG. 7 shows a CV evaluation result for the half-cell of Example 1;

FIG. 8 shows a CV evaluation result for the half-cell of Comparative Example 3;

FIG. 9 is a graph showing Nyquist plots as an initial impedance evaluation for the half-cells of Example 1 and Comparative Example 3; and

FIG. 10 is a graph of cycle-life characteristics of the full cells manufactured according to Example 1, Comparative Example 2, and Comparative Example 3.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

The singular expression includes the plural expression unless the context clearly dictates otherwise.

As used herein, “combination thereof” means a mixture, laminate, composite, copolymer, alloy, blend, reaction product, and the like of the constituents.

Herein, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

In the drawings, the thickness of layers, films, panels, regions, etc., are exaggerated for clarity and like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

In addition, “layer” herein includes not only a shape formed on the whole surface when viewed from a plan view, but also a shape formed on a partial surface.

In addition, the average particle diameter may be measured by a method well known to those skilled in the art, e.g., it may be measured by a particle size analyzer, or may be measured by a transmission electron microscopic photograph or a scanning electron microscopic photograph. Alternatively, it is possible to obtain an average particle diameter value by measuring a size using a dynamic light scattering method, performing data analysis, counting the number of particles for each particle size range, and calculating from this. The average particle diameter may be measured with a microscope image or a particle size analyzer, and may mean a diameter (D50) of particles having a cumulative volume of 50 volume % in a particle size distribution.

Herein, “or” is not to be construed as an exclusive meaning, for example, “A or B” is construed to include A, B, or A and B, and the like.

Negative Electrode for Rechargeable Lithium Battery

In some example embodiments, a negative electrode for a rechargeable lithium battery may include a negative electrode current collector, a negative electrode catalyst layer on the negative electrode current collector, and a lithium ion conductive layer on the negative electrode catalyst layer. Such a negative electrode may be referred to as a type of precipitation-type negative electrode. The negative electrode catalyst layer may function as a negative electrode active material, but generally, rather than functioning as a negative electrode active material, it may be said to play a role of inducing reversible precipitation of lithium.

The precipitation-type negative electrode may further include a lithium metal layer formed during initial charging between the negative electrode current collector and the negative electrode catalyst layer. A portion or the whole of the lithium metal layer formed during charging may be detached during discharging, and may be re-formed during subsequent charging. This lithium metal layer may function as a negative electrode active material and may realize reversible capacity. If such a precipitation-type negative electrode is applied, a thin-film battery may be manufactured at low cost. The precipitation-type negative electrode may also be desirable for application to an all-solid-state rechargeable battery.

A precipitation-type negative electrode for a rechargeable lithium battery according to some example embodiments may induce lithium to be precipitated in a good form, may increase reversible capacity and efficiency, and may suppress corrosion of a negative electrode current collector.

The negative electrode current collector may include, e.g., a copper foil, a stainless steel (SUS) foil, a nickel foil, a titanium foil, or a combination thereof.

The negative electrode catalyst layer may serve as a catalyst and may include, e.g., a metal, a carbon material, or a combination thereof.

Herein, the metal may include gold, platinum, palladium, silicon, silver, aluminum, bismuth, tin, zinc, or a combination thereof. The metal may be a single metal or an alloy composed of two or more elements. These metals may be referred to as a type of lithiophilic metal and may effectively induce lithium metal to be precipitated by charging.

The metal may be in the form of particles, e.g., and its average particle diameter (D50) may be less than or equal to about 4 μm, e.g., about 5 nm to about 4 μm, about 5 nm to about 3 μm, about 5 nm to about 2 μm, about 10 nm to about 1 μm, about 10 nm to about 500 nm, about 10 nm to about 300 nm, or about 10 nm to about 100 nm. If the metal satisfies the aforementioned particle diameter ranges, it may be easy to be coated on the negative electrode current collector and may effectively induce lithium precipitation without adversely affecting the battery.

The carbon material may be crystalline carbon, amorphous carbon, or a combination thereof. In an implementation, the carbon material may be amorphous carbon. The amorphous carbon may be, e.g., carbon black, activated carbon, acetylene black, Denka black, Ketjen black, or a combination thereof. Such amorphous carbon may induce lithium to be precipitated in a good form in the negative electrode.

The negative electrode catalyst layer may include, e.g., both a metal and a carbon material. In addition, the negative electrode catalyst layer may include a composite in which a metal and a carbon material may be combined, e.g., a composite in which a metal may be supported on a carbon material. Alternatively, the metal and the carbon material may be simply mixed or dispersed in the negative electrode catalyst layer.

If the negative electrode catalyst layer includes both the metal and carbon material, a mixing ratio of the metal and the carbon material may be about 1:1 to about 1:50, e.g., about 1:1 to about 1:40, about 1:1 to about 1:30, about 1:2 to about 1:25, about 1:2 to about 1:20, or about 1:3 to about 1:10 in a weight ratio. If the content ratio of the metal and the carbon material satisfies the above ranges, it may be easy to be coated on the negative electrode current collector, and it may be possible to effectively induce lithium metal to be precipitated in a good form, to increase a reversible capacity of the rechargeable lithium battery and to reduce the cost.

The negative electrode catalyst layer may further include a binder. The binder may be a water-insoluble binder, a water-soluble binder, or a combination thereof.

The water-insoluble binder may include, e.g., polyvinyl chloride, carboxylated polyvinyl chloride, polyvinyl fluoride, an ethylene oxide-containing polymer, an ethylene propylene copolymer, polystyrene, polyvinylpyrrolidone, polyurethane, polytetrafluoro ethylene, polyvinylidene fluoride, polyethylene, polypropylene, polyamideimide, polyimide, or a combination thereof.

The water-soluble binder may include a rubber binder or a polymer resin binder. The rubber binder may be, e.g., a styrene-butadiene rubber, an acrylated styrene-butadiene rubber, an acrylonitrile-butadiene rubber, an acrylic rubber, a butyl rubber, a fluororubber, or a combination thereof. The polymer resin binder may be, e.g., polyethylene oxide, polyvinylpyrrolidone, polyepichlorohydrin, polyphosphazene, polyacrylonitrile, an ethylene propylene diene copolymer, polyvinylpyridine, chlorosulfonated polyethylene, latex, a polyester resin, an acrylic resin, a phenol resin, an epoxy resin, polyvinyl alcohol, or a combination thereof.

If a water-soluble binder is used as the negative electrode binder, a thickener capable of imparting viscosity may be used together, and the thickener may include, e.g., a cellulose-based compound. The cellulose-based compound may include carboxymethyl cellulose, hydroxypropylmethyl cellulose, methyl cellulose, an alkali metal salt thereof, or a combination thereof. The alkali metal may be Na, K, or Li. A content of the thickener may be about 0.1 parts by weight to about 3 parts by weight based on 100 parts by weight of the negative electrode active material.

The binder may be included in an amount of about 0.1 wt % to about 15 wt %, e.g., about 0.5 wt % to about 10 wt %, or about 1 wt % to about 8 wt %, based on 100 wt % of the negative electrode catalyst layer. In this case, components in the negative electrode catalyst layer may be well combined without impairing performance of the rechargeable lithium battery, and the negative electrode catalyst layer may be well attached to the negative electrode current collector.

In addition, the negative electrode catalyst layer may further include general additives such as a filler, a dispersant, an ion conducting agent, and the like.

The negative electrode catalyst layer may be formed thinner than a thickness of a typical negative electrode active material layer. In an implementation, the negative electrode catalyst layer may have a thickness of about 100 nm to about 50 μm, e.g., about 500 nm to about 40 μm, about 1 μm to about 30 μm, about 1 μm to about 20 μm, or about 5 μm to about 15 μm. Within the above thickness range, the negative electrode catalyst layer may effectively promote precipitation of lithium metal without impairing the performance of the rechargeable lithium battery.

Meanwhile, the negative electrode for a rechargeable lithium battery according to some example embodiments may further include a thin film between the current collector and the negative electrode catalyst layer. The thin film may include an element capable of forming an alloy with lithium. The element capable of forming an alloy with lithium may be, e.g., gold, silver, zinc, tin, indium, silicon, aluminum, bismuth, and the like, which may be used alone or an alloy of more than one. The thin film may further planarize the precipitation form of the lithium metal layer and further improve characteristics of the rechargeable lithium battery. The thin film may be formed, e.g., in a vacuum deposition method, a sputtering method, a plating method, and the like. The thin film may have, e.g., a thickness of about 1 nm to about 100 nm, or about 5 nm to about 50 nm.

A negative electrode for a rechargeable lithium battery according to some example embodiments may be characterized in that a lithium ion conductive layer may be formed on the aforementioned negative electrode catalyst layer. The lithium ion conductive layer may induce lithium metal to be evenly precipitated into the negative electrode by charging, and may suppress side reactions at the interface between the electrolyte and the negative electrode. In an implementation, the lithium ion conductive layer may effectively suppress a phenomenon in which a negative electrode current collector may be corroded by an electrolyte or the like and a problem in which a negative electrode current collector may be degraded due to movement of components of the negative electrode current collector into the electrolyte.

The lithium ion conductive layer may include, e.g., a lithium-metal composite oxide. The lithium-metal composite oxide may refer to an oxide including lithium and a metal other than lithium. The metal may be a concept including general metals, transition metals, semi-metals, and the like. These metals may include one or more elements, e.g., Al, B, Ba, Ca, Ce, Co, Cr, Cu, Fe, La, Mg, Mn, Mo, Nb, Si, Sr, Ta, Ti, V, W, Zn, or Zr. The lithium-metal composite oxide may include one type of these metals, or may include two types, three types, or more of these metals.

Examples of the lithium-metal composite oxide may include a lithium titanium oxide, a lithium zirconium oxide, a lithium aluminum oxide, a lithium niobium oxide, a lithium lanthanum oxide, a lithium tantalum oxide, a lithium zinc oxide, a lithium titanium zirconium oxide, a lithium lanthanum titanium oxide, a lithium lanthanum zirconium oxide, a lithium lanthanum titanium zirconium oxide, a lithium lanthanum zirconium aluminum oxide, a lithium strontium tantalum zirconium oxide, or a combination thereof. Such a compound may effectively suppress a side reaction at an interface between a negative electrode and an electrolyte without acting as resistance in a rechargeable lithium battery, and may promote precipitation of lithium.

A thickness of the lithium ion conductive layer may be thinner than the thickness of the negative electrode catalyst layer, and may be, e.g., about 1 nm to about 50 nm, about 1 nm to about 40 nm, about 1 nm to about 30 nm, about 1 nm to about 20 nm, about 1 nm to about 10 nm, or about 1 nm to about 5 nm. As such, the lithium ion conductive layer formed with a very thin thickness may not act as resistance in the rechargeable lithium battery, may not adversely affect energy density, and may effectively solve problems at the interface without interfering with the movement of lithium ions.

The lithium ion conductive layer may be formed by, e.g., an atomic layer deposition (ALD) method, and thus may be formed in a very thin and flat shape.

Rechargeable Lithium Battery

In some example embodiments, a rechargeable lithium battery including the negative electrode, a positive electrode, and an electrolyte may be provided.

Positive Electrode

The positive electrode may include a positive electrode current collector and a positive electrode active material layer on the positive electrode current collector. The positive electrode active material layer may include a positive electrode active material and optionally a binder and/or a conductive material.

The positive electrode active material may be applied without limitation as long as it is generally used in a rechargeable lithium battery. In an implementation, the positive electrode active material may be a compound being capable of intercalating and deintercalating lithium, and may include a compound represented by one of the following chemical formulas.

LiₐA_{1-b}X_{b}D₂ (0.90≤a≤1.8, 0≤b≤0.5);

LiₐA_{1-b}X_{b}O_{2-c}D_{c} (0.90≤a≤1.8, 0≤b≤0.5, 0≤c≤0.05);

LiₐE_{1-b}X_{b}O_{2-c}D_{c} (0.90≤a≤1.8, 0≤b≤0.5, 0≤c≤0.05);

LiₐE_{2-b}X_{b}O_{4-c}D_{c} (0.90≤a≤1.8, 0≤b≤0.5, 0≤c≤0.05);

LiₐNi_{1-b-c}Co_{b}X_{c}D_{α} (0.90≤a≤1.8, 0≤b≤0.5, 0≤c≤0.5, 0<α≤2);

LiₐNi_{1-b-c}Co_{b}X_{c}O_{2-α}T_{α} (0.90≤a≤1.8, 0≤b≤5, 0≤c≤0.05, 0<α<2);

LiₐNi_{1-b-c}Co_{b}X_{c}O_{2-α}T₂ (0.90≤a≤1.8, 0≤b≤0.5, 0≤c≤0.05, 0<α<2);

LiₐNi_{1-b-c}Mn_{b}X_{c}D_{α} (0.90≤a≤1.8, 0≤b≤0.5, 0≤c≤0.05, 0<α≤2);

LiₐNi_{1-b-c}Mn_{b}X_{c}O_{2-α}T_{α} (0.90≤a≤1.8, 0≤b≤0.5, 0≤c≤0.05, 0<α<2);

LiₐNi_{1-b-c}Mn_{b}X_{c}O_{2-α}T₂ (0.90≤a≤1.8, 0≤b≤0.5, 0≤c≤0.05, 0<α<2);

LiₐNi_{b}E_{c}G_{d}O₂ (0.90≤a≤1.8, 0≤b≤0.9, 0≤c≤0.5, 0.001≤d≤0.1);

LiₐNi_{b}Co_{c}Mn_{d}GeO₂ (0.90≤a≤1.8, 0≤b≤0.9, 0≤c≤0.5, 0≤d≤0.5, 0.001≤e≤0.1);

LiₐNiG_{b}O₂ (0.90≤a≤1.8, 0.001≤b≤0.1);

LiₐCoG_{b}O₂ (0.90≤a≤1.8, 0.001≤b≤0.1);

LiₐMn_{1-b}G_{b}O₂ (0.90≤a≤1.8, 0.001≤b≤0.1);

LiₐMn₂G_{b}O₄ (0.90≤a≤1.8, 0.001≤b≤0.1);

LiₐMn_{1-g}G_{g}PO₄ (0.90≤a≤1.8, 0≤g≤0.5);

QO₂; QS₂; LiQS₂;

V₂O₅; LiV₂O₅;

LiZO₂;

LiNiVO₄;

Li_{(3-f)}J₂(PO₄)₃ (0≤f≤2);

Li_{(3-f})Fe₂(PO₄)₃ (0≤f≤2);

LiₐFePO₄ (0.90≤a≤1.8).

In the chemical formulas, A may be, e.g., Ni, Co, Mn, or a combination thereof, X may be, e.g., Al, Ni, Co, Mn, Cr, Fe, Mg, Sr, V, rare earth elements, or a combination thereof, D may be, e.g., O, F, S, P, or a combination thereof, E may be, e.g., Co, Mn, or a combination thereof, T may be, e.g., F, S, P, or a combination thereof, G may be, e.g., Al, Cr, Mn, Fe, Mg, La, Ce, Sr, V, or a combination thereof, Q may be, e.g., Ti, Mo, Mn, or a combination thereof, Z may be, e.g., Cr, V, Fe, Sc, Y, or a combination thereof, and J may be, e.g., V, Cr, Mn, Co, Ni, Cu, or a combination thereof.

The positive electrode active material may be, e.g., a lithium cobalt oxide (LCO), a lithium nickel oxide (LNO), a lithium nickel cobalt oxide (NC), a lithium nickel cobalt aluminum oxide (NCA), a lithium nickel cobalt manganese oxide (NCM), a lithium nickel manganese oxide (NM), a lithium manganese oxide (LMO), or lithium iron phosphate (LFP).

The positive electrode active material may include a lithium nickel-based oxide represented by Chemical Formula 1, a lithium cobalt-based oxide represented by Chemical Formula 2, a lithium iron phosphate-based compound represented by Chemical Formula 3, or a combination thereof.

Liₐ₁Niₓ₁M¹_{y1}M²_{1-x1-y1}O₂ [Chemical Formula 1]

In Chemical Formula 1, 0.9≤a1≤1.8, 0.3≤x1≤1, 0≤y1≤0.7, and M¹ and M² may be each independently one or more element, e.g., Al, B, Ba, Ca, Ce, Co, Cr, Cu, F, Fe, Mg, Mn, Mo, Nb, P, S, Si, Sr, Ti, V, W, or Zr.

Liₐ₂Coₓ₂M³₁₋ₓ₂O₂ [Chemical Formula 2]

In Chemical Formula 2, 0.9≤a2≤1.8, 0.6≤x2≤1, and M³ may be one or more element, e.g., Al, B, Ba, Ca, Ce, Cr, Cu, F, Fe, Mg, Mn, Mo, Nb, P, S, Si, Sr, Ti, V, W, or Zr.

Liₐ₃Feₓ₃M⁴₍₁₋ₓ₃₎PO₄ [Chemical Formula 3]

In Chemical Formula 3, 0.9≤a3≤1.8, 0.6≤x3≤1, and M⁴ may be one or more element, e.g., Al, B, Ba, Ca, Ce, Co, Cr, Cu, F, Fe, Mg, Mn, Mo, Nb, P, S, Si, Sr, Ti, V, W, and Zr.

An average particle diameter (D50) of the positive electrode active material may be about 1 μm to about 25 μm, e.g., about 3 μm to about 25 μm, about 5 μm to about 25 μm, about 5 μm to about 20 μm, about 8 μm to about 20 μm, or about 10 μm to about 18 μm. A positive electrode active material having such a particle size range may be harmoniously mixed with other components in a positive electrode active material layer and may realize high capacity and high energy density.

The positive electrode active material may be in the form of secondary particles formed by aggregating a plurality of primary particles, or may be in the form of single particles. In addition, the positive electrode active material may have a spherical or near-spherical shape, or may have a polyhedral or amorphous shape.

The binder may include, e.g., polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like.

In the positive electrode active material layer, a content of the binder may be about 0.1 wt % to about 10 wt %, or about 1 wt % to about 5 wt % based on a total weight of the positive electrode active material layer.

The conductive material may be used to impart conductivity to the electrode, and may include, e.g., a carbon-based material such as natural graphite, artificial graphite, carbon black, acetylene black, Ketjen black, a carbon fiber, a carbon nanofiber, a carbon nanotube, and the like; a metal-based material containing copper, nickel, aluminum, silver and the like and in the form of a metal powder or a metal fiber; a conductive polymer such as a polyphenylene derivative; or a mixture thereof.

In the positive electrode active material layer, a content of the conductive material may be about 0.1 wt % to about 10 wt % or about 1 wt % to about 5 wt % based on a total weight of the positive electrode active material layer.

The positive electrode current collector may be an aluminum foil, a stainless steel foil, and the like.

Electrolyte

In the rechargeable lithium battery according to some example embodiments, the electrolyte may be a non-aqueous organic electrolyte solution or a solid electrolyte. An all-solid-state battery to which a solid electrolyte is applied will be described later, and an electrolyte solution using a non-aqueous organic solvent will be described here.

The electrolyte solution may include a non-aqueous organic solvent and a lithium salt.

The non-aqueous organic solvent may serve as a medium for transmitting ions taking part in the electrochemical reaction of a battery. The non-aqueous organic solvent may include a carbonate-based, ester-based, ether-based, ketone-based, alcohol-based, or aprotic solvent. The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. The ester-based solvent may include methyl acetate, ethyl acetate, n-propyl acetate, dimethylacetate, methylpropionate, ethylpropionate, γ-butyrolactone, decanolide, valerolactone, mevalonolactone, caprolactone, and the like. The ether-based solvent may include dibutyl ether, tetraglyme, diglyme, dimethoxyethane, 2-methyltetrahydrofuran, tetrahydrofuran, and the like and the ketone-based solvent may include cyclohexanone, and the like. In addition, the alcohol-based solvent may include ethanol, isopropyl alcohol, and the like, and the aprotic solvent may include nitriles such as R—CN (wherein R may be a C2 to C20 linear, branched, or cyclic hydrocarbon group, and may include a double bond, an aromatic ring, or an ether bond), amides such as dimethylformamide, and the like, dioxolanes such as 1,3-dioxolane, 1,4-dioxolane, and the like, sulfolanes, and the like.

The non-aqueous organic solvent may be used singularly or in a mixture. If the organic solvent is used in a mixture, the mixture ratio may be controlled in accordance with a desirable battery performance.

Furthermore, the carbonate-based solvent may include a mixture with a cyclic carbonate and a chain carbonate. The cyclic carbonate and chain carbonate may be mixed together in a volume ratio of about 1:1 to about 1:9, and if the mixture is used as an electrolyte, it may have enhanced electrolyte performance.

The non-aqueous organic solvent may further include an aromatic hydrocarbon-based solvent as well as the carbonate-based solvent. Herein, the carbonate-based solvent and the aromatic hydrocarbon-based solvent may be mixed together in a volume ratio of about 1:1 to about 30:1.

Examples of the aromatic hydrocarbon-based solvent may include, e.g., benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, or a combination thereof.

The electrolyte solution may further include vinylene carbonate or an ethylene carbonate-based compound as an additive in order to improve cycle-life of a battery.

Examples of the ethylene carbonate-based compound may include difluoro ethylenecarbonate, chloroethylene carbonate, dichloroethylene carbonate, bromoethylene carbonate, dibromoethylene carbonate, nitroethylene carbonate, cyanoethylene carbonate, or fluoroethylene carbonate.

The lithium salt dissolved in the non-aqueous organic solvent may supply lithium ions in a battery, enable a basic operation of a rechargeable lithium battery, and improve transportation of the lithium ions between positive and negative electrodes.

Examples of the lithium salt may include, e.g., LiPF₆, LiBF₄, LiSbF₆, LiAsF₆, LiN(SO₂C₂F₅)₂, Li(CF₃SO₂)₂N, LiN(SO₃C₂F₅)₂, Li(FSO₂)₂N (lithium bis(fluorosulfonyl)imide; LiFSI), LiC₄F₉SO₃, LiClO₄, LiAlO₂, LiAlCl₄, LiPO₂F₂, LiN(CₓF₂ₓ₊₁SO₂)(C_{y}F_{2y+1}SO₂), wherein x and y may be natural numbers, e.g., an integer ranging from 1 to 20, lithium difluoro(bisoxalato) phosphate, LiCl, LiI, LiB(C₂O₄)₂ (lithium bis(oxalato) borate; LiBOB), and lithium difluoro(oxalato)borate (LiDFOB).

The lithium salt may be used in a concentration ranging from about 0.1 M to about 2.0 M. If the lithium salt is included at the above concentration range, an electrolyte may have excellent performance and lithium ion mobility due to optimal electrolyte conductivity and viscosity.

Separator

Meanwhile, the rechargeable lithium battery may include a separator separating a positive electrode and a negative electrode if a non-aqueous organic electrolyte is applied. The separator may separate the positive electrode and the negative electrode and may provide a passage for lithium ions to move, and any separator commonly used in a lithium ion battery may be used. That is, an electrolyte having low resistance to ion movement of the electrolyte and excellent ability to absorb the electrolyte may be used. In an implementation, the separator may include glass fibers, polyester, polyethylene, polypropylene, polytetrafluoroethylene, or a combination thereof, and may be in the form of a nonwoven fabric or a woven fabric. In an implementation, polyolefin-based polymer separators such as polyethylene and polypropylene may be mainly used, and coated separators including ceramic components or polymer materials may be used to secure heat resistance or mechanical strength, and may optionally be used in a single or multi-layer structure.

All-Solid-State Rechargeable Battery

Some example embodiments may provide an all-solid-state rechargeable battery including the aforementioned negative electrode, a positive electrode, and a solid electrolyte layer between the positive electrode and the negative electrode. The aforementioned precipitation-type negative electrode may be suitable for application to a thin film-type all-solid-state rechargeable battery to which a solid electrolyte may be applied, and may be advantageous in improving battery performance by solving problems at the interface between the solid electrolyte and the negative electrode.

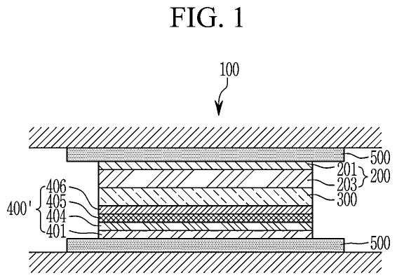

The all-solid-state rechargeable battery may also be referred to as an all-solid-state battery or an all-solid-state rechargeable lithium battery. FIG. 1 shows a cross-sectional view of an all-solid-state rechargeable battery including a precipitation-type negative electrode according to some example embodiments. Referring to FIG. 1, a negative electrode 400′ may include a negative electrode current collector 401, a negative electrode catalyst layer 405 on the negative electrode current collector 401, and a lithium ion conductive layer 406 on the negative electrode catalyst layer. In the negative electrode 400′, high-density lithium metal may be deposited or electrodeposited between the negative electrode current collector 401 and the negative electrode catalyst layer 405 by charging, and this may function as a negative electrode active material. Accordingly, in an all-solid-state battery in which charging has been performed one or more times, the precipitation-type negative electrode may include a negative electrode current collector 401, a lithium metal layer 404 on the negative electrode current collector 401, a negative electrode catalyst layer 405 on the lithium metal layer 404, and a lithium ion conductive layer 406 on the negative electrode catalyst layer 405. The lithium metal layer 404 may mean a layer of the lithium metal and the like precipitated during the charge of the battery and may be called to be a metal layer, a negative electrode active material layer, or the like.

The all-solid-state rechargeable battery 100 may further include at least one elastic layer 500 on the outside of at least either one of the positive electrode 200 and the negative electrode 400′. The positive electrode 200 may include a positive electrode current collector 201 and a positive electrode active material layer 203 on the positive electrode current collector 201. Although one electrode assembly including the negative electrode 400′, the solid electrolyte layer 300, and the positive electrode 200 is shown in FIG. 1, an all-solid-state battery may be manufactured by stacking two or more electrode assemblies.

Negative Electrode

The descriptions previously described in the negative electrode for a rechargeable lithium battery may be applied to a negative electrode for an all-solid-state rechargeable battery according to some example embodiments.

The negative electrode current collector 401 may likewise include a copper foil, a stainless steel foil, a nickel foil, a titanium foil, or a combination thereof. Among them, e.g., the negative electrode 401 current collector for an all-solid-state rechargeable battery may include a copper foil.

The stainless steel foil may have a very low reactivity with a solid electrolyte, particularly a sulfide-based solid electrolyte, and may be suitable for use as a negative electrode current collector of an all-solid-state rechargeable battery. However, stainless steel foil may be inferior in terms of economy due to its high cost, and it may be difficult to thin it, and thus there is a problem that it may inhibit the improvement of the energy density of the all-solid-state rechargeable battery and may be disadvantageous in processability.

On the other hand, copper foil may be economically advantageous due to its relatively low cost and may be thinned, and thus it may be a more suitable negative current collector for all-solid-state rechargeable batteries. However, the copper current collector may continuously cause side reactions with the sulfide-based solid electrolyte, and copper ions may move to the solid electrolyte layer to deteriorate the sulfide-based solid electrolyte. A method to solve this problem may be needed. If a protective film is formed on the surface of a precipitation-type negative electrode, the problem at the interface may not be effectively solved, a lithium ion conductivity may be lowered, an energy density may be lowered, and a resistance may be increased, resulting in lowered battery performance.

Accordingly, if the negative electrode 400′ according to some example embodiments is applied, the lithium ion conductive layer 406 may effectively prevent copper ions from moving to the solid electrolyte layer 300 while improving the lithium ion conductivity, and in addition, penetration of the sulfide-based solid electrolyte into the negative electrode 400′ may be suppressed. In addition, since the lithium ion conductive layer 406 may be formed to a very thin thickness, resistance may not be increased and energy density may not be adversely affected. Additionally, due to the introduction of the lithium ion conductive layer 406, a problem in which the sulfide-based solid electrolyte may be reduced by a voltage difference between the sulfide-based solid electrolyte and the negative electrode 400′ may be effectively suppressed.

In an implementation, if the negative electrode according to some example embodiments is applied to an all-solid-state rechargeable battery in which a copper foil is applied as a negative electrode current collector and a sulfide-based solid electrolyte is applied to a solid electrolyte layer, the problems occurring at the interface between the negative electrode and the solid electrolyte may be effectively controlled while lowering the cost and maximizing the performance of the all-solid-state rechargeable battery, and thus deterioration of the sulfide-based solid electrolyte due to inflow of copper ions may be suppressed, and corrosion of the copper foil current collector may be suppressed.

Other specific details of the negative electrode may be the same as those described above for the negative electrode for a rechargeable lithium battery, and thus detailed descriptions thereof will be omitted.

Positive Electrode

The positive electrode 200 for an all-solid-state rechargeable battery may also include the positive electrode current collector 201 and the positive electrode active material layer 203 on the positive electrode current collector. The positive electrode active material layer 203 may include a positive electrode active material and a solid electrolyte, and may optionally include a binder and/or a conductive material.

Details of the positive electrode active material, binder, and conductive material may be the same as those described in the positive electrode for a rechargeable lithium battery, and thus are omitted.

The solid electrolyte included in the positive electrode 200 for an all-solid-state rechargeable battery may include, e.g., a sulfide-based solid electrolyte, an oxide-based solid electrolyte, or a combination thereof, and, e.g., may include a sulfide-based solid electrolyte having high ion conductivity.

The sulfide-based solid electrolyte particles may be, e.g., Li₂S—P₂S₅, Li₂S—P₂S₅—LiX (wherein X may be a halogen element, e.g., I or Cl), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (wherein m and n may each be an integer and Z may be Ge, Zn or Ga), Li₂S—GeS₂, Li₂S—SiS₂—Li₃PO₄, Li₂S—SiS₂-LiₚMO_{q} (wherein p and q may be integers and M may be P, Si, Ge, B, Al, Ga, or In), or a combination thereof.

Such a sulfide-based solid electrolyte may be obtained by, e.g., mixing Li₂S and P₂S₅ at a mole ratio of about 50:50 to about 90:10 or about 50:50 to about 80:20 and optionally performing heat treatment. Within the above mixing ratio range, a sulfide-based solid electrolyte having excellent ion conductivity may be prepared. The ion conductivity may be further improved by further including SiS₂, GeS₂, B₂S₃, and the like as other components.

A method of mixing sulfur-containing raw materials for preparing a sulfide-based solid electrolyte may be mechanical milling or a solution method. The mechanical milling may be a method of mixing the starting materials into microparticles by putting the starting materials and a ball mill in a reactor and vigorously stirring them. In the case of using the solution method, a solid electrolyte may be obtained as a precipitate by mixing the starting materials in a solvent. In addition, in the case of performing heat treatment for the mixture, crystals of the solid electrolyte may be more robust and ion conductivity may be improved. In an implementation, the sulfide-based solid electrolyte may be prepared by mixing sulfur-containing raw materials and heat-treating the same two or more times. In this case, a sulfide-based solid electrolyte having high ion conductivity and robustness may be prepared.

In an implementation, the sulfide-based solid electrolyte particles may include argyrodite-type sulfide. The argyrodite-type sulfide may be, e.g., represented by the chemical formula, LiₐM_{b}P_{c}S_{d}Aₑ (wherein a, b, c, d, and e may all be 0 or more and 12 or less, M may be Ge, Sn, Si, or a combination thereof, and A may be F, Cl, Br, or I), and as a specific example, it may be represented by the chemical formula of Li₇₋ₓPS₆₋ₓAₓ (wherein x may be 0.2 or more and 1.8 or less, and A may be F, Cl, Br, or I). In an implementation, the argyrodite-type sulfide may be Li₃PS₄, Li₇P₃Su, Li₇PS₆, Li₆PS₅Cl, Li₆PS₅Br, Li_{5.8}PS_{4.8}Cl_{1.2}, Li_{6.2}PS_{5.2}Br_{0.8}, and the like.

The sulfide-based solid electrolyte particles including such argyrodite-type sulfide may have high ion conductivity close to the range of about 10⁻⁴ to about 10⁻² S/cm, which is be the ion conductivity of general liquid electrolytes at room temperature, and may form an intimate bond between the positive electrode active material and the solid electrolyte without causing a decrease in ion conductivity, and furthermore, an intimate interface between the electrode layer and the solid electrolyte layer. An all-solid-state battery including the same may have improved battery performance such as rate capability, coulombic efficiency, and cycle-life characteristics.

The argyrodite-type sulfide-based solid electrolyte may be prepared, e.g., by mixing lithium sulfide and phosphorus sulfide, and optionally lithium halide. Heat treatment may be performed after mixing them. The heat treatment may include, e.g., two or more heat treatment steps.

An average particle diameter (D50) of the sulfide-based solid electrolyte particles according to some example embodiments may be less than or equal to about 5.0 μm, e.g., about 0.1 μm to about 5.0 μm, about 0.1 μm to about 4.0 μm, about 0.1 μm to about 3.0 μm, about 0.5 μm to about 2.0 μm, or about 0.1 μm to about 1.5 μm. Alternatively, the sulfide-based solid electrolyte particles may be small particles having an average particle diameter (D50) of about 0.1 μm to about 1.0 μm, or a large particle having an average particle diameter (D50) of about 1.5 μm to about 5.0 μm depending on a location or purpose of use.

The sulfide-based solid electrolyte particles having these particle size ranges may effectively penetrate between solid particles in the battery, and may have excellent contact with the electrode active materials and connectivity between solid electrolyte particles. The average particle diameter of the sulfide-based solid electrolyte particles may be measured using a microscope image, and, e.g., a particle size distribution may be obtained by measuring the size of about 20 particles in a scanning electron microscope image, and D50 may be calculated therefrom.

Meanwhile, the solid electrolyte may include an oxide-based inorganic solid electrolyte. The oxide-based inorganic solid electrolyte may include, e.g., Li₁₊ₓTi₂₋ₓAl(PO₄)₃ (LTAP) (0≤x≤4), Li_{1+x+y}AlₓTi₂₋ₓSi_{y}P_{3-y}O₁₂ (0<x<2, 0≤y<3), BaTiO₃, Pb(Zr,Ti)O₃ (PZT), Pb₁₋ₓLaₓZr_{1-y}Ti_{y}O₃ (PLZT) (0≤x<1, 0≤y<1), PB(Mg₃Nb_{2/3})O₃—PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y}(PO₄)₃, 0<x<2, 0<y<3), Li_{1+x+y}(Al, Ga)ₓ(Ti, Ge)₂₋ₓSi_{y}P_{3-y}O₁₂ (0≤x≤1, 0≤y≤1), lithium lanthanum titanate (LiₓLa_{y}TiO₃, 0<x<2, 0<y<3), Li₂O, LiAlO₂, Li₂O—Al₂O₃—SiO₂—P₂O₅—TiO₂—GeO₂-based ceramics, Garnet-based ceramics Li₃₊ₓLa₃M₂O₁₂ (M may be Te, Nb, or Zr; x may be an integer of 1 to 10), or a combination thereof.

A content of the solid electrolyte in the positive electrode for an all-solid-state rechargeable battery may be about 0.5 wt % to about 35 wt %, e.g., about 1 wt % to about 35 wt %, about 5 wt % to about 30 wt %, about 8 wt % to about 25 wt %, or about 10 wt % to about 20 wt %. This may be a content based on a total weight of the components in the positive electrode, and specifically, it may be referred to as a content based on a total weight of the positive electrode active material layer.

In an implementation, the positive electrode for an all-solid-state rechargeable battery may include about 55 wt % to about 98.5 wt % of the positive electrode active material, about 0.5 wt % to about 35 wt % of the solid electrolyte, about 0.5 wt % to about 5 wt % of the binder, and about 0.5 wt % to about 5 wt % of the conductive material based on 100 wt % of the positive electrode active material layer. In this case, the positive electrode can realize high capacity and ion conductivity.

Solid Electrolyte Layer

The solid electrolyte layer 300 may include a sulfide-based solid electrolyte or an oxide-based solid electrolyte. Details of the sulfide-based solid electrolyte and the oxide-based solid electrolyte are as described above.

Referring to FIG. 1, in an implementation, the solid electrolyte included in the positive electrode 200 and the solid electrolyte included in the solid electrolyte layer 300 may include the same compound or different compounds. In an implementation, if both the positive electrode 200 and the solid electrolyte layer 300 include an argyrodite-type sulfide-based solid electrolyte, overall performance of the all-solid-state rechargeable battery may be improved. In addition, e.g., if both the positive electrode 200 and the solid electrolyte layer 300 include the aforementioned coated solid electrolyte, the all-solid-state rechargeable battery may implement excellent initial efficiency and cycle-life characteristics while implementing high capacity and high energy density.

Meanwhile, the average particle diameter (D50) of the solid electrolyte included in the positive electrode 200 may be smaller than the average particle diameter (D50) of the solid electrolyte included in the solid electrolyte layer 300. In this case, overall performance may be improved by increasing the mobility of lithium ions while maximizing the energy density of the all-solid-state battery. In an implementation, the average particle diameter (D50) of the solid electrolyte included in the positive electrode 200 may be about 0.1 μm to about 1.0 μm, or about 0.1 μm to about 0.8 μm, and the average particle diameter (D50) of the solid electrolyte included in the solid electrolyte layer 300 may be about 1.5 μm to about 5.0 μm, or about 2.0 μm to about 4.0 μm, or about 2.5 μm to about 3.5 μm. If the particle size ranges are satisfied, the energy density of the all-solid-state rechargeable battery may be maximized while the transfer of lithium ions may be facilitated, so that resistance may suppressed, and thus the overall performance of the all-solid-state rechargeable battery may be improved. Herein, the average particle diameter (D50) of the solid electrolyte may be measured through a particle size analyzer using a laser diffraction method. Alternatively, about 20 particles may be arbitrarily selected from a micrograph of a scanning electron microscope or the like, the particle size is measured, and a particle size distribution may be obtained, and the D50 value may be calculated.

The solid electrolyte layer may further include a binder in addition to the solid electrolyte. Herein, the binder may include a styrene butadiene rubber, polytetrafluoroethylene, polyvinylidene fluoride, polyethylene, an acrylate-based polymer, or a combination thereof. The acrylate-based polymer may be, e.g., butyl acrylate, polyacrylate, polymethacrylate, or a combination thereof.

The solid electrolyte layer may be formed by adding a solid electrolyte to a binder solution, coating it on a base film, and drying the resultant. The solvent of the binder solution may be isobutyryl isobutyrate, xylene, toluene, benzene, hexane, or a combination thereof. Since a forming process of the solid electrolyte layer is well known in the art, a detailed description thereof will be omitted.

A thickness of the solid electrolyte layer may be, e.g., about 10 μm to about 150 μm.

A solid electrolyte layer may further include an alkali metal salt and/or an ionic liquid and/or a conductive polymer.

The alkali metal salt may be, e.g., a lithium salt. A content of the lithium salt in the solid electrolyte layer may be greater than or equal to about 1 M, e.g., about 1 M to about 4 M. In this case, the lithium salt may improve ion conductivity by improving lithium ion mobility of the solid electrolyte layer.

The lithium salt may include, e.g., LiSCN, LiN(CN)₂, Li(CF₃SO₂)₃C, LiC₄F₉SO₃, LiN(SO₂CF₂CF₃)₂, LiCl, LiF, LiBr, LiI, LiB(C₂O₄)₂, LiBF₄, LiBF₃(C₂F₅), lithium bis(oxalato) borate (LiBOB), lithium oxalyldifluoroborate (LIODFB), lithium difluoro(oxalato) borate (LiDFOB), lithium bis(trifluoromethanesulfonyl)imide (LiTFSI, LiN(SO₂CF₃)₂), lithium bis(fluorosulfonyl)imide (LiFSI, LiN(SO₂F)₂), LiCF₃SO₃, LiAsF₆, LiSbF₆, LiClO₄, or a mixture thereof.

In addition, the lithium salt may be an imide-based salt, e.g., the imide-based lithium salt may be lithium bis(trifluoromethanesulfonyl) imide (LiTFSI, LiN(SO₂CF₃)₂), and lithium bis(fluorosulfonyl)imide (LiFSI, LiN(SO₂F)₂). The lithium salt may maintain or improve ion conductivity by appropriately maintaining chemical reactivity with the ionic liquid.

The ionic liquid may have a melting point below room temperature, so it may be in a liquid state at room temperature and may refer to a salt or room temperature molten salt composed of ions alone.

The ionic liquid may be a compound including at least one cation, e.g., ammonium-based, pyrrolidinium-based, pyridinium-based, pyrimidinium-based, imidazolium-based, piperidinium-based, pyrazolium-based, oxazolium-based, pyridazinium-based, phosphonium-based, sulfonium-based, triazolium-based, or a mixture thereof, and at least one anion, e.g., BF₄—, PF₆—, AsF₆—, SbF₆—, AlCl₄—, HSO₄—, ClO₄—, CH₃SO₃—, CF₃CO₂—, Cl—, Br—, I—, BF₄—, SO₄—, CF₃SO₃—, (FSO₂)₂N—, (C₂F₅SO₂)₂N—, (C₂F₅SO₂)(CF₃SO₂)N—, or (CF₃SO₂)₂N—.

The ionic liquid may be, e.g., N-methyl-N-propylpyrrolidinium bis(trifluoromethanesulfonyl)imide N-butyl-N-methylpyrrolidium bis(3-trifluoromethylsulfonyl) imide, 1-butyl-3-methylimidazolium bis(trifluoromethylsulfonyl)amide, or 1-ethyl-3-methylimidazolium bis(trifluoromethylsulfonyl)amide.

A weight ratio of the solid electrolyte and the ionic liquid in the solid electrolyte layer may be about 0.1:99.9 to about 90:10, e.g., about 10:90 to about 90:10, about 20:80 to about 90:10, about 30:70 to about 90:10, about 40:60 to about 90:10, or about 50:50 to about 90:10. The solid electrolyte layer satisfying the above ranges may maintain or improve ion conductivity by improving the electrochemical contact area with the electrode. Accordingly, the energy density, discharge capacity, rate capability, etc. of the all-solid-state battery may be improved.

The all-solid-state battery may be a unit cell having a structure of a positive electrode/solid electrolyte layer/negative electrode, a bicell having a structure of positive electrode/solid electrolyte layer/negative electrode/solid electrolyte layer/positive electrode, or a stacked battery in which the structure of the unit cell is repeated.

The shape of the all-solid-state battery may be, e.g., a coin type, a button type, a sheet type, a stack type, a cylindrical shape, a flat type, and the like. In addition, the all-solid-state battery may be applied to a large-sized battery used in an electric vehicle or the like. In an implementation, the all-solid-state battery may also be used in a hybrid vehicle such as a plug-in hybrid electric vehicle (PHEV). In addition, it may be used in a field requiring a large amount of power storage, and may be used, e.g., in an electric bicycle or a power tool.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### Example 1

1. Manufacture of Negative Electrode

A copper foil negative electrode current collector was prepared. A catalyst was prepared by mixing carbon black and silver (Ag) having an average particle diameter (D50) of about 60 nm in a weight ratio of 75:25, and 0.25 g of the catalyst was mixed in 2 g of an NMP solution including 7 wt % of a polyvinylidene fluoride binder to prepare a negative electrode catalyst layer composition. The negative electrode catalyst layer composition was coated on the copper foil negative electrode current collector and dried, forming an about 10 μm-thick negative electrode catalyst layer on the copper foil. On the negative electrode catalyst layer, a 5 nm-thick lithium ion conductive layer was formed of a lithium zirconium oxide (LZO) in an ALD method, preparing a precipitation-type negative electrode according to Example 1.

2. Manufacture of all-Solid-State Half-Cell

An argyrodite-type solid electrolyte of Li₆PS₅Cl having an average particle diameter (D50) of about 3 μm was added to an IBIB solvent including an acryl-based binder, preparing a composition for a solid electrolyte layer. The composition was cast on a releasing film and dried at room temperature drying, preparing a solid electrolyte layer.

The solid electrolyte layer was stacked on a lithium metal counter electrode, and the negative electrode was stacked thereon. This was sealed into a pouch shape and pressed with a warm isostatic press (WIP) at a high temperature of 80° C. at 500 MPa for 30 minutes, manufacturing an all-solid-state half-cell.

3. Manufacture of all-Solid-State Full-Cell

Apart from the half-cell, an all-solid-state full cell was manufactured by using the following positive electrode.

84.9 wt % of LiNi_{0.945}Co_{0.04}Al_{0.015}O₂ of a positive electrode active material, 13.51 wt % of Li₆PS₅Cl of an argyrodite-type sulfide-based solid electrolyte, 1 wt % of a PVdF binder, and 0.35 wt % of carbon nanotube of a conductive material were added to isobutyryl isobutyrate (IBIB) of a solvent, preparing a positive electrode composition. The prepared positive electrode composition was coated on a positive electrode current collector and then, dried and roll-pressed, preparing a positive electrode.

On the positive electrode, the solid electrolyte layer was stacked, and the negative electrode was stacked thereon and then, pressed with a warm isostatic press (WIP) in the same manner as in the half-cell, manufacturing the all-solid-state full cell.

### Example 2

A negative electrode, an all-solid-state half-cell, and a full cell were manufactured in the same manner as in Example 1 except that a lithium titanium oxide (LTO) instead of the lithium zirconium oxide was applied to the lithium ion conductive layer of the negative electrode.

### Example 3

A negative electrode, an all-solid-state half-cell, and a full cell were manufactured in the same manner as in Example 1 except that a lithium aluminum oxide (LAO) instead of the lithium zirconium oxide was applied to the lithium ion conductive layer of the negative electrode.

### Comparative Example 1

A negative electrode, an all-solid-state half-cell, and a full cell were manufactured in the same manner as in Example 1 except that the lithium ion conductive layer was not formed in the negative electrode.

### Comparative Example 2

A negative electrode, an all-solid-state half-cell, and a full cell were manufactured in the same manner as in Example 1 except that a carbon-coated copper foil was used as the negative electrode current collector, and the lithium ion conductive layer was not formed in the negative electrode.

### Comparative Example 3

A negative electrode, an all-solid-state half-cell, and a full cell were manufactured in the same manner as in Example 1 except that zirconia (ZrO₂) instead of the lithium zirconium oxide was applied to the lithium ion conductive layer of the negative electrode.

### Comparative Example 4

A negative electrode, an all-solid-state half-cell, and a full cell were manufactured in the same manner as in Example 1 except that titania (TiO₂) instead of the lithium zirconium oxide was applied to the lithium ion conductive layer of the negative electrode.

### Comparative Example 5

A negative electrode, an all-solid-state half-cell, and a full cell were manufactured in the same manner as in Example 1 except that alumina (Al₂O₃) instead of the lithium zirconium oxide was applied to the lithium ion conductive layer of the negative electrode.

### Evaluation Example 1: CV Evaluation of all-Solid-State Half-Cells of Comparative Examples

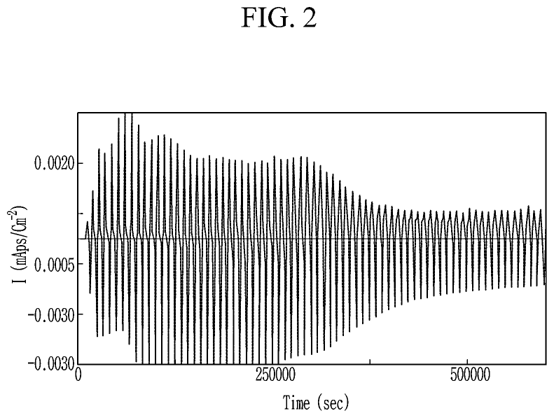

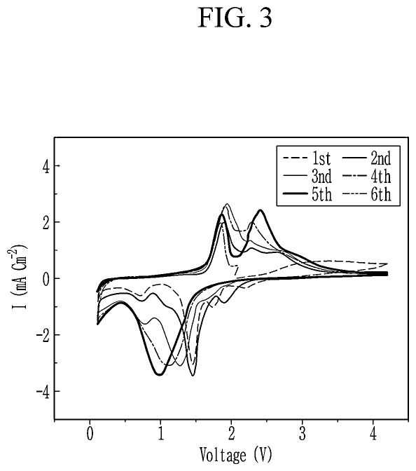

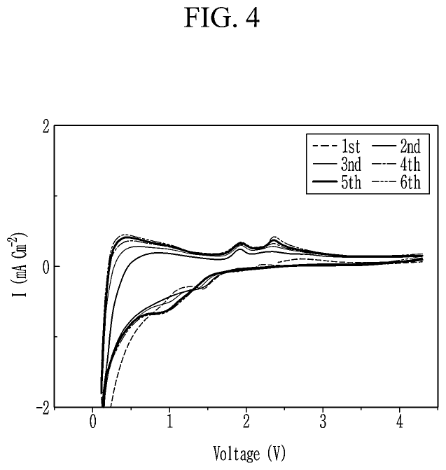

A cyclic voltammetry (CV) evaluation of the half-cell of Comparative Example 1 was performed, and then, a graph of a current change with time is shown in FIG. 2, and a graph of current change with a voltage is shown in FIG. 3. In addition, the CV evaluation of the half-cell of Comparative Example 2 was performed, and a graph of a current change with a voltage is shown in FIG. 4.

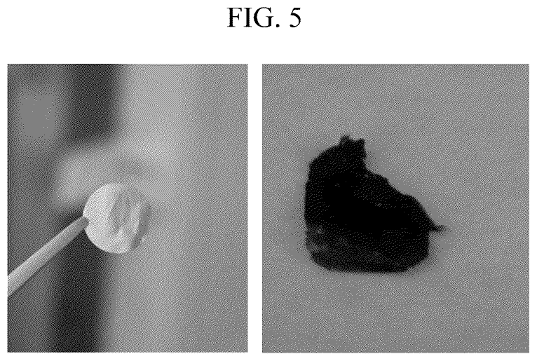

In addition, an image of the copper foil negative electrode current collector used in Comparative Example 1 is shown on the left of FIG. 5, and an image of the copper foil negative electrode current collector taken by dissembling the half-cell of Comparative Example 1 after 30 cycles is shown on the right of FIG. 5.

Referring to FIGS. 2 to 5, in Comparative Example 1, an electrochemical side reaction severely occurred at the copper foil negative electrode current collector during the cell operation, and in Comparative Example 2 of applying the negative electrode current collector obtained by coating carbon on a copper foil, the severe electrochemical side reaction also occurred.

### Evaluation Example 2: TOF-SIMS Analysis of Copper Foil Negative Current Collector after Cycles

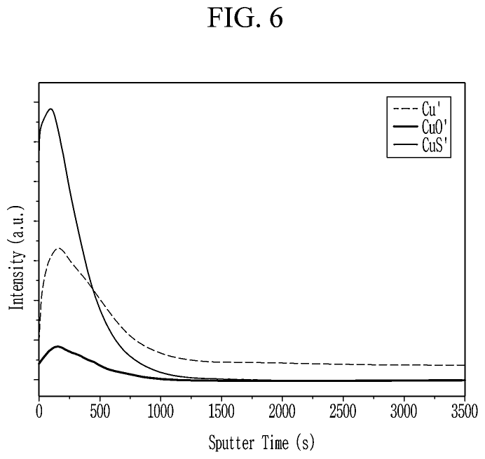

After 100 cycles of the all-solid-state half-cell of Comparative Example 1, a profile according to a depth on the surface of the copper foil negative electrode current collector was analyzed through TOF-SIMS (time-of-flight secondary ion mass spectrometry), and specifically, a concentration of Cu⁻, CuO⁻, and CuS⁻ components was analyzed, and the results are shown in FIG. 6.

Referring to FIG. 6, after 100 cycles, on the surface of the copper foil negative electrode current collector of Comparative Example 1, CuS⁻, a product of a reaction of the sulfide-based solid electrolyte and the copper, was confirmed to be thickly present. Accordingly, the sulfide solid electrolyte and the copper foil negative electrode current collector turned out to have a severe reaction on the interface.

### Evaluation Example 3: Evaluation of Battery Cell Performance

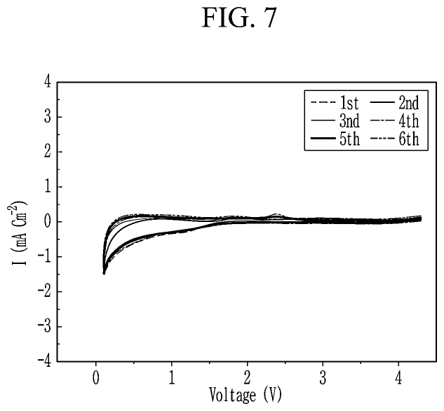

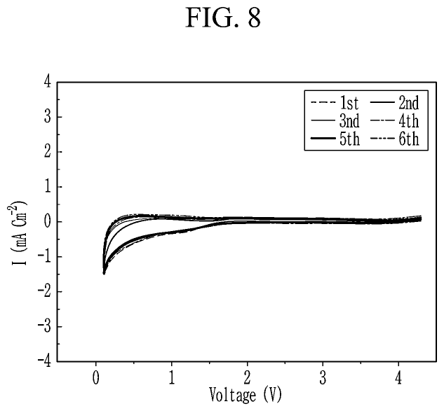

The half-cells of Example 1 and Comparative Example 3 were subject to a cyclic voltammetry (CV) evaluation, and each graph of a current change with a voltage is shown in FIGS. 7 and 8, respectively.

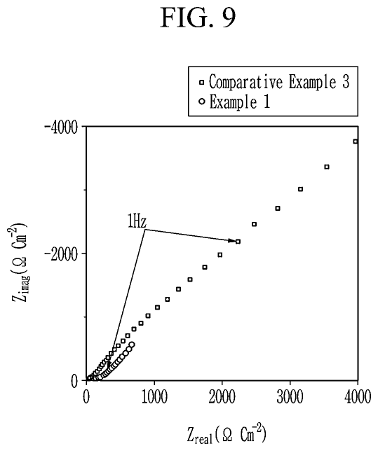

Referring to FIGS. 7 and 8, Example 1 and Comparative Example 3 prevented the reaction between copper current collector and solid electrolyte and thus exhibited a sharp drop in current density according to the side reaction. Subsequently, the half-cells of Example 1 and Comparative Example 3 were evaluated with respect to initial impedance. The initial impedance was evaluated by measuring resistance after applying a voltage bias of 10 mV within a frequency range of 10⁶ Hz to 0.1 MHz according to a 2-probe method at 25° C. with an impedance/gain-phase analyzer (Solartron 1260A, Sciospec Scientific Instruments GmbH), and the result of a Nyguist plot is shown in FIG. 9. Referring to FIG. 9, compared with Comparative Example 3, Example 1 exhibited much lower resistance.

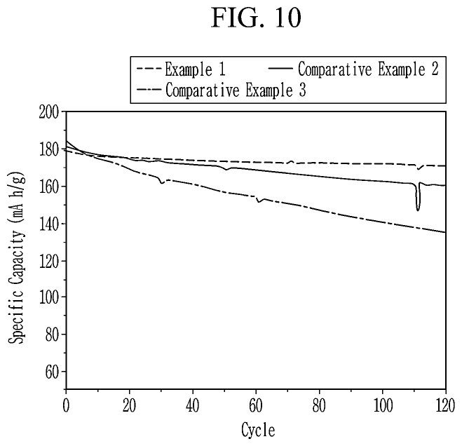

Lastly, the full cells of Example 1 and Comparative Examples 2 and 3 were charged to an upper limit voltage of 4.25 V at a constant current of 0.1 C and discharged to a cut-off voltage of 2.5 V at 0.1 C at 45° C. for initial charge and discharge. Subsequently, the cells were repeatedly charged and discharged at 0.33 C within a voltage range of 2.5 V to 4.25 V at 45° C. and then, evaluated with respect to cycle-life characteristics. FIG. 10 shows specific capacity according to the number of cycles.

Referring to FIG. 10, Example 1 exhibited excellent cycle-life characteristics, compared with Comparative Examples 2 and 3. In Example 1, in which a lithium ion conductive layer was formed on a negative electrode catalyst layer, the cycle-life characteristics of the all-solid-state battery cell were improved by effectively preventing a reaction between solid electrolyte and negative electrode current collector and simultaneously suppressing an increase in resistance.

By way of summation and review, the rechargeable lithium battery may be composed of a positive electrode, a negative electrode, and an electrolyte. Recently, a precipitation-type negative electrode has been proposed as the negative electrode for a rechargeable lithium battery. The precipitation-type negative electrode may be a negative electrode which may not include a negative electrode active material during the battery assembly but on which a lithium metal with a high density may be precipitated or electrodeposited during the charge of the battery and may serve as the negative electrode active material. However, the precipitation-type negative electrode may have the technical tasks of precipitating the lithium metal not as a resin phase but as a flat shape at a high concentration and achieving high capacity by the precipitated lithium.

On the other hand, this precipitation-type negative electrode may be suitably applied to an all-solid-state rechargeable battery. However, the precipitation-type negative electrode may have a side reaction on the interface with a solid electrolyte layer of the all-solid-state rechargeable battery, the solid electrolyte may corrode a current collector of the precipitation-type negative electrode or may be deteriorated by components of the negative electrode current collector flown into the solid electrolyte, the solid electrolyte may be reduced due to a voltage difference between solid electrolyte and negative electrode.

In contrast, example embodiments provide, a negative electrode for a rechargeable lithium battery capable of increasing reversible capacity by inducing high-concentration lithium precipitation on a negative electrode and suppressing a side reaction at an interface between a negative electrode and an electrolyte, and a rechargeable lithium battery including the same. In addition, provided is an all-solid-state battery capable of suppressing a side reaction at the interface between a precipitation-type negative electrode and the solid electrolyte, suppressing a phenomenon of reduction of a solid electrolyte, and effectively suppressing phenomena in which a negative electrode current collector is corroded by a solid electrolyte or components of the negative electrode current collector is introduced into the solid electrolyte and the electrolyte is deteriorated.

The negative electrode for a rechargeable lithium battery according to some example embodiments may induce good precipitation of lithium by charging to increase reversible capacity and efficiency, and suppress corrosion of the negative electrode current collector, and may suppress a side reaction at the interface between the negative electrode and the electrolyte to improve performance such as cycle-life characteristics of the rechargeable lithium battery. In addition, the all-solid-state rechargeable battery according to some example embodiments may effectively suppress problems of reduction or deterioration of the solid electrolyte and corrosion of the negative electrode current collector by the solid electrolyte, thereby improving overall performance such as cycle-life characteristics.

Example embodiments have been disclosed herein, and although specific terms are employed, they are used and are to be interpreted in a generic and descriptive sense only and not for the purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A negative electrode for a rechargeable lithium battery, the negative electrode comprising:
a negative electrode current collector;
a negative electrode catalyst layer on the negative electrode current collector; and
a lithium ion conductive layer on the negative electrode catalyst layer.

2. The negative electrode as claimed in claim 1, wherein the negative electrode current collector includes a copper foil, a stainless steel (SUS) foil, a nickel foil, a titanium foil, or a combination thereof.

3. The negative electrode as claimed in claim 1, wherein the negative electrode catalyst layer includes a metal, a carbon material, or a combination thereof.

4. The negative electrode as claimed in claim 3, wherein the metal includes gold, platinum, palladium, silicon, silver, aluminum, bismuth, tin, zinc, or a combination thereof.

5. The negative electrode as claimed in claim 3, wherein the carbon material includes amorphous carbon.

6. The negative electrode as claimed in claim 3, wherein the negative electrode catalyst layer includes the metal and the carbon material in a weight ratio of about 1:1 to about 1:50.

7. The negative electrode as claimed in claim 1, wherein a thickness of the negative electrode catalyst layer is about 100 nm to about 50 km.

8. The negative electrode as claimed in claim 1, further comprising a lithium metal layer formed during initial charging between the negative electrode current collector and the negative electrode catalyst layer.

9. The negative electrode as claimed in claim 1, wherein:
the lithium ion conductive layer includes a lithium-metal composite oxide,
the lithium-metal composite oxide includes lithium and a metal other than lithium, and
the metal is one or more element selected from Al, B, Ba, Ca, Ce, Co, Cr, Cu, Fe, La, Mg, Mn, Mo, Nb, Si, Sr, Ta, Ti, V, W, Zn, and Zr.

10. The negative electrode as claimed in claim 1, wherein the lithium ion conductive layer includes a lithium titanium oxide, a lithium zirconium oxide, a lithium aluminum oxide, a lithium niobium oxide, a lithium lanthanum oxide, a lithium tantalum oxide, a lithium zinc oxide, a lithium titanium zirconium oxide, a lithium lanthanum titanium oxide, a lithium lanthanum zirconium oxide, a lithium lanthanum titanium zirconium oxide, a lithium lanthanum zirconium aluminum oxide, a lithium strontium tantalum zirconium oxide, or a combination thereof.

11. The negative electrode as claimed in claim 1, wherein a thickness of the lithium ion conductive layer is about 1 nm to about 50 nm.

12. A rechargeable lithium battery, comprising:
the negative electrode as claimed in claim 1;
a positive electrode; and
an electrolyte.

13. An all-solid-state rechargeable battery, comprising:
the negative electrode as claimed in claim 1;
a positive electrode; and
a solid electrolyte layer between the positive electrode and the negative electrode.

14. The all-solid-state rechargeable battery as claimed in claim 13, wherein the solid electrolyte layer includes a sulfide-based solid electrolyte.

15. The all-solid-state rechargeable battery as claimed in claim 14, wherein the sulfide-based solid electrolyte includes an argyrodite-type sulfide.

16. The all-solid-state rechargeable battery as claimed in claim 15, wherein the argyrodite-type sulfide includes Li₃PS₄, Li₇P₃S₁₁, Li₇PS₆, Li₆PS₅Cl, Li₆PS₅Br, Li_{5.8}PS_{4.8}Cl_{1.2}, Li_{6.2}PS_{5.2}Br_{0.8}, or a combination thereof.

17. The all-solid-state rechargeable battery as claimed in claim 14, wherein an average particle diameter (D50) of the sulfide-based solid electrolyte is about 0.1 μm to about 5.0 μm.

18. The all-solid-state rechargeable battery as claimed in claim 13, wherein the negative electrode current collector includes a copper foil.
